(19) United States
(12) Patent Application Publication
(10) Pub. No.: US 2015/0066550 A1
(43) Pub. Date: Mar. 5, 2015

(54) FLOW LINE DATA ANALYSIS DEVICE, SYSTEM, NON-TRANSITORY COMPUTER READABLE MEDIUM AND METHOD

(71) Applicant: NEC Corporation, Tokyo (JP)

(72) Inventor: Hiroo Harada, Tokyo (JP)

(73) Assignee: NEC Corporation, Tokyo (JP)

(21) Appl. No.: 14/389,209

(22) PCT Filed: Mar. 18, 2013
(86) PCT No.: PCT/JP2013/001835

§ 371 Date: Sep. 29, 2014

(30) Foreign Application Priority Data
Mar. 30, 2012 (JP) 2012-080281

(51) Int. Cl. G06Q 10/06

(52) U.S. Cl. CPC G06Q 10/063
USPC 705/7.11

(57) ABSTRACT

A flow line analysis device according to the present invention includes: a log storage unit which stores work log including key information which encompasses at least one of worker information, slip information and work item, and work information associated with key information; a flow line storage unit which stores a plurality of partial flow line data associated with the worker; and a control unit, wherein the control unit extracts work information associated with a specific key information from the work log, determines whether each of the plurality of partial flow line data which includes flow line work information which satisfies a predetermined condition defined by work information, and associates the key information with the flow line data when it is determined that the flow line data includes the flow line work information.

### TECHNICAL FIELD

The present invention relates to technique for analyzing flow line data.

### BACKGROUND ART

As technique related to the present invention, patent literature (PTL) 1 discloses a technique for use in collecting trends of customers. In this technique, an association of customer flow line data, which has been recognized by a flow line recognition system installed in a particular region of a store, with customer trading data, which has been processed by a settlement apparatus, is made by utilizing person images of customers.

Concretely, a collection apparatus for collecting trends of customers selects the flow line data associated with a person who has been located within an image monitoring region from among flow line data per person stored in a flow line database. Further, this collection apparatus selects sales floor image data at the time when the person corresponding to the selected flow line data has been located within the image monitoring region from a sales floor image database, and extracts a person image corresponding to the person from the selected sales floor image data.

Moreover, the collection apparatus collates the extracted person image with each of customer image data per customer stored in a customer image database, and searches for customer image data, which has been obtained in advance by photographing the person corresponding to the extracted person image. When the desired customer image data has been detected, the collection apparatus associates identification information corresponding to trading data associated with the detected customer image data with a piece of identification information corresponding to the selected flow line data, and stores the identification information corresponding to trading data. Such technique as described above has been disclosed in PTL 1.

### CITATION LIST

### Patent Literature

[PTL 1] Japanese Unexamined Patent Application Publication No. 2011-170565

### SUMMARY OF INVENTION

### Technical Problem

However, in such the technique disclosed in PTL 1, since person images resulting from photographing customers at a position near a point of sale system (POS) terminal are used, when generating a single flow line data related to an identical person from a plurality of flow line data, each of the plurality of flow line data needs to be of such a high degree of accuracy that can identify a person image of the identical person.

An exemplary object of the present invention to solve the aforementioned problem is to provide a flow line analysis device, a system, a program and a method for generating a single flow line data related to an identical person by interlinking a plurality of flow line data each related to the identical person without making collation on a person image basis.

### Solution to Problem

A flow line analysis device according to the present invention includes a log storage unit which stores work log including key information which encompasses at least one of worker information, slip information and work item, and work information associated with key information; a flow line storage unit which stores a plurality of partial flow line data associated with the worker; and a control unit, wherein the control unit extracts work information associated with a specific key information from the work log, determines whether each of the plurality of partial flow line data which includes flow line work information which satisfies a predetermined condition defined by work information, and associates the key information with the flow line data when it is determined that the flow line data includes the flow line work information.

A flow line analysis method according to the present invention includes: storing work log including key information which encompasses at least one of worker information, slip information and work item, and work information associated with key information; storing a plurality of partial flow line data associated with a worker; extracting work information associated with a specific the key information from the work log; determining whether each of the plurality of partial flow line data which includes flow line work information which satisfies a predetermined condition determined in accordance with the work information; and associating the specific key information with the flow line data when it is determined that each of a plurality of specific partial flow line data included in the plurality of partial flow line data includes flow line work information.

A flow line analysis program which makes a computer operate as functions for analyzing flow line data according to the present invention includes: a log storage unit which stores work log including key information which encompasses at least one of worker information, slip information and work item, and work information associated with the key information; a flow line storage unit which stores each of a plurality of partial flow line data of the worker; an extraction unit which extracts work information associated with specific key information from the work log; a determination unit which determines whether each of the plurality of partial flow line data which includes flow line work information which satisfies a predetermined condition defined by work information; a flow line data generation unit which generates a interlinked flow line data associating with a plurality of partial flow line data when it is determined that each of the plurality of partial flow line data includes the flow line work information.

### Advantageous Effects of Invention

The present invention makes it possible to provide a flow line analysis device, a system, a program and a method for generating a single flow line data related to an identical person by interlinking a plurality of flow line data each related to the identical person without making collation on a personal image basis.

### BRIEF DESCRIPTION OF DRAWINGS

FIG. 1 A block diagram according to an exemplary embodiment 1 of the present invention

FIG. 2 A flowchart according to the exemplary embodiment 1 of the present invention

FIG. 3 A block diagram according to an exemplary embodiment 2 of the present invention

FIG. 4A An example of flow line data according to the exemplary embodiment 2 of the present invention

FIG. 4B An example of flow line data according to the exemplary embodiment 2 of the present invention

FIG. 5A An example of flow line data according to the exemplary embodiment 2 of the present invention

FIG. 5B An example of flow line data according to the exemplary embodiment 2 of the present invention

FIG. 6 An example of flow line data according to the exemplary embodiment 2 of the present invention

FIG. 7 An example of flow line data according to the exemplary embodiment 2 of the present invention

FIG. 8 A flowchart according to the exemplary embodiment 2 of the present invention

FIG. 9 An example a flow line work task information list according to the exemplary embodiment 2 of the present invention

FIG. 10 A diagram of a system configuration according to an exemplary embodiment 3 of the present invention

FIG. 11 An example of flow line data according to the exemplary embodiment 3 of the present invention

FIG. 12 An example of work log according to the exemplary embodiment 3 of the present invention

FIG. 13A An example of shelf assignment information according to the exemplary embodiment 3 of the present invention

FIG. 13B An example of shelf assignment information according to the exemplary embodiment 3 of the present invention

FIG. 14 A flowchart according to the exemplary embodiment 3 of the present invention

FIG. 15 A diagram according to another exemplary embodiment of the present invention

### DESCRIPTION OF EMBODIMENTS

Hereinafter, exemplary embodiments of the present invention will be described with reference to the drawings. It is to be noted here that the following exemplary embodiments will be described by way of an example of an association of worker flow line data with a specific worker in a warehouse or a factory, but the exemplary embodiment is not limited to this. The invention can be also applied to the identification of worker using a other means, such as a face collation at a specific passing location. Here, the worker include the whole of person skilled in work such as an acquisition of articles, an arrangement of articles, processing of goods (bolting, drilling and cutting with tools, painting and the like). Besides human being, a riding machine such as a forklift, an automated robot, a trained animal and the like can be also included in the workers. Further, the work performed by the worker includes the work for an acquisition of articles, the work for an arrangement of articles, the work for processing of goods (such as the work using an installed tool of large size, an installation of a wheel and an installation of a door in the assembly of cars in a train-car assembling factory), and the like.

The present invention is unnecessarily to be limited to configurations and operations illustrated in drawings of exemplary embodiments described below and, appropriately, the configurations and the operations can be subjected to an addition of, and/or a change to, other configurations and other operations, respectively. Further, individual constituent components of exemplary embodiments described below may be included in a single device as a whole, or may be separately included in each of a plurality of devices which are functionally independent with one another.

### Exemplary Embodiment 1

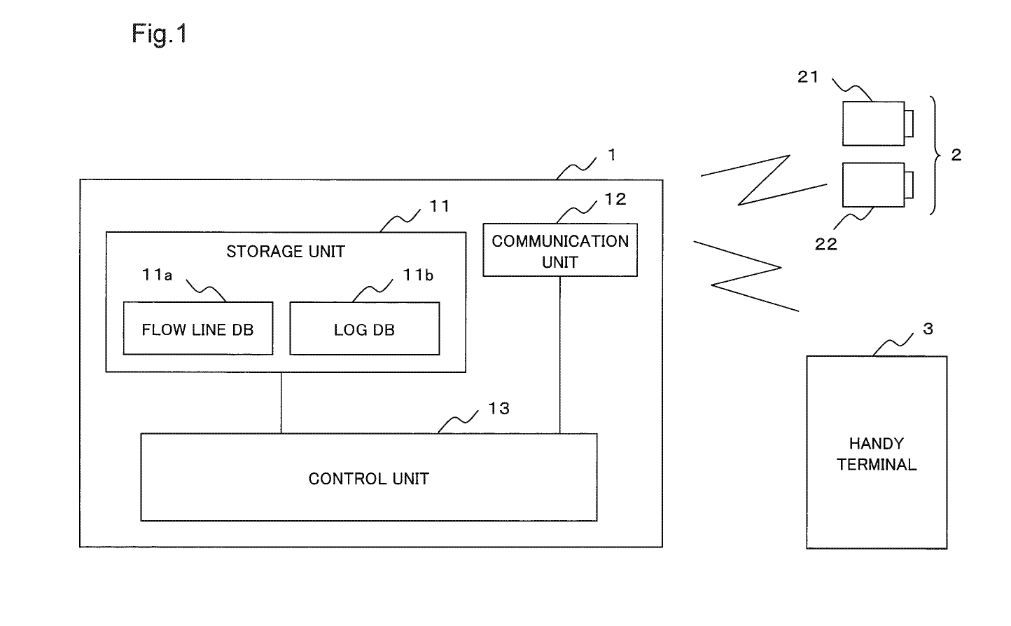

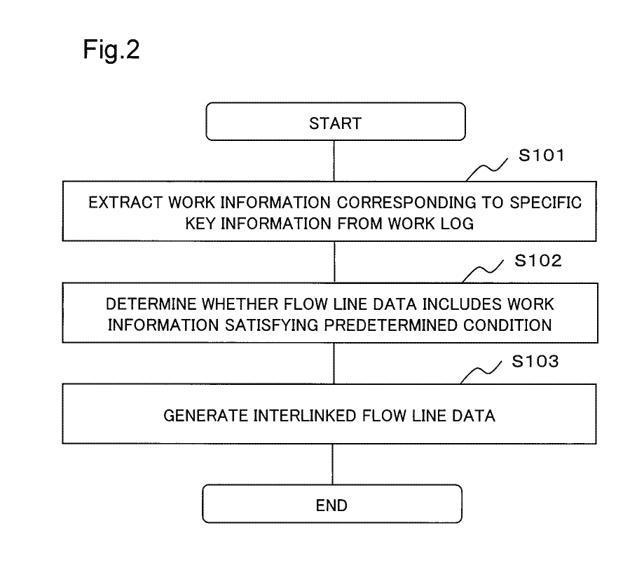

First, an exemplary embodiment 1 will be described with reference to FIGS. 1 and 2.

FIG. 1 is block diagram illustrating a flow line data analysis system of this exemplary embodiment 1. The flow line data analysis system of this exemplary embodiment 1 includes a flow line data analysis device 1, a plurality of location detection devices 2 and a handy terminal 3. Further, in exemplary embodiments and drawings described below, a case where the location detection device 2 is constituted by a camera will be described as an example of the location detection device 2, but the location detection device is available if it is capable of detecting the location of the worker who moves inside a warehouse or a factory and outputting the location of the worker to the flow line data analysis device 1, such as a wireless terminal carried by a worker.

The flow line data analysis device 1 includes a storage unit 11, a communication unit 12 and a control unit 13.

The storage unit 11 includes a flow line database (DB) 11a (also referred to as a flow line storage unit) and a log database (DB) 11b (also referred to as a log storage unit). The flow line DB 11a stores therein a plurality of partial flow line data each generated by the control unit 13 from image data from the location detection devices 2, as well as interlinked flow line data resulting from interlinking the plurality of partial flow line data. Here, flow line data corresponds to a track of the worker who moves inside the warehouse or the factory, and may include place information and time information, each of the representing a movement history. The place information in this case may be information which designates a location relative to an appropriately determined specific reference point by using coordinate information (referred to as warehouse coordinates) which is specified by using a distance of an east-west direction element, a distance of a south-north direction element and a distance of a vertical direction element each from the reference point. In this case, for example the flow line data is handled information recording in the form of an array in which warehouse coordinates of the worker and clock time.

Further, a region inside the warehouse or the factory is segmented so as to form a grid pattern, such as a square pattern on a Go board, which is obtained by vertically and horizontally arranging line segments at even intervals, and in order to uniquely specify each of the grids, a set of rows and a set of columns resulting from the segmentation are denoted, for each of the sets, by numbers or signs, such as [I, II, III, IV, . . . ] or [a, b, c, d, . . . ]. A list resulting from recording, for each of the grids (also referred to as cells), an entry clock time, an exit clock time and the like, together with sign for specifying the location of the each of the grids (this sign being referred to as a grid number or a cell number) may be handled as flow line data.

Moreover, the flow line data may be a list which is generated by utilizing an image analysis technique, and which includes actions, such as an acquisition of articles, and an arrangement of articles, processing of goods, each supposed to have been performed by the worker, as well as pieces of time information each being associated with the actions, and representing a piece of time information at which the worker has taken the corresponding action. The action, which is supposed to have been performed by the worker, means an action, such as stopping, squatting, passing by a place where articles are arranged, stretching the arm, picking up an article, placing an article on a shelf, bolting, drilling and cutting using tools, installing a component, or painting. In this description, hereinafter, the action suggesting that the worker has performed work will be also referred to as flow line work action information.

Further, the flow line data may be flow line data generating from data outputted from a single location detection device 2, or may be flow line data rebuilding data outputted from each of a plurality of location detection devices 2 such that the flow line data is associated with data related to an identical worker and is composed of flow line data including passing position or passing clock time which are arranged continuously in time series. The log DB 11b stores a work log which has been transmitted from the handy terminal 3 via the communication unit 12.

Here, the work log includes data representing variety of information related to the article which has been acquired or arranged by the worker and data representing a work item (bolting, an installation of components, or the like). The work log forms a list containing key information and work information associated with the key information. The key information includes at least one of the worker information related to worker (a name, a code and/or the like), slip information (slip number and/or the like) and a work item (bolting, an installation of component, and the like). Further, the work information includes information related to the work item corresponding to the work performed by the worker (hereinafter, these kinds of information being collectively also referred to as work-item work information), as well as article work information. Here, the work-item work information includes, for example, groups of: clock time (hereinafter, also referred to as log clock time information) at which the worker has carried out the work corresponding to the work item; place at which the worker has carried out the work corresponding to the work item; tool information related to tool for use in the work; and the like. Further, the article work information includes article information (article numbers, article names, and/or the like, each related to the article having been acquired by the worker); total numbers, as well as total numbers of articles, each related to articles having been used in a work the worker has performed; clock time at which the worker has worked on an article (hereinafter, which will be unified into the log clock time information); and the like.

The storage unit 11 may be constituted by a read only memory (ROM), a magnetic storage memory device, such as a flash memory, or a non-volatile memory, such as a hard disk, or may be constituted by a volatile memory, such as a random access memory (RAM). Further, each of the flow line DB 11a and the log DB 11b may be stored in storage media which are physically different from each other, or both of the flow line DB 11a and the log DB 11b may be stored in the same storage medium.

The communication unit 12 communicates with each of the location detection devices 2 and the handy terminal 3 via wireless communication. Besides, the communication unit 12 may communicate with each of them via short distance wireless communication, such as Bluetooth (registered trademark) or infrared communication, or wired communication via cables or the like. Further, the communication unit 12 is capable of communicating with servers or the like by connecting with a network, such as the Internet or an intranet.

The control unit 13 detects the worker who is moving within a flow line recognition region and generates the partial flow line data related to this worker by applying an image processing technique to image data from one of the location detection devices 2. Herein, the control unit 13 stores the generated the partial flow line data into the storage unit 11. Here, the control unit 13 generates a plurality of partial flow line data by using image data from each of a plurality of detection devices, and interlinks specific partial flow line data which are associated with identical key information. Further, the control unit 13 is capable of generating a single interlinked flow line data related to an identical worker, and storing the interlinked flow line data into the storage unit 11. The control unit 13 is capable of, from a plurality of partial flow line data, detecting flow line work action information each suggesting action that is supposed to have been worked on the article by the worker. Further, the control unit 13 is also capable of, from the partial flow line data, extracting flow line work action information being associated with flow line work action information and including a piece of time information, a piece of place information and the like, which are related to a work having been performed by a worker, such as an acquisition of articles, an arrangement of articles, or processing of goods. Moreover, the control unit 13 extracts work information (such as, article work information) corresponding to a specific key information, from work log. Further, the control unit 13 determines whether each of a plurality of partial flow line data includes flow line work information which is included in the extracted flow line work information and which satisfies a predetermined condition each determined in accordance with the extracted work information. For example, work time standard associated with work item may be stored in the storage unit 11 in advance, and the control unit 13 may determine whether, for each of the plurality of partial flow line data, extracted work-item work information satisfies the predetermined condition determined from the work time standard. Further, in the case where it is determined that each of a plurality of partial flow line data includes flow line work information which satisfies the predetermined condition, the control unit 13 associate the specific key information included in the work log with the plurality of partial flow line data.

Here, the control unit 13 may be constituted by a central processing unit (CPU) or the like. Further, the control unit 13 may be physically configured to cause individual operations to be executed by a single CPU or the like or may cause each of the operations to be performed by a plurality of CPUs or the like.

Each of the location detection devices 2 detects the location of the worker moving inside the warehouse or the factory, and outputs the location of the worker to the flow line data analysis device 1. For example, a camera may be employed as each of the location detection devices 2. The camera itself may possess a processing mechanism for a tracing function for tracing the flow line of the worker, or a control unit or a different externally connected device, which has received image data signals from the camera functioning as the location detection device, may possess a function equivalent to the tracing function. Further, a method for generating partial flow line data for tracing a worker is realized by using, for example, a kalman filter or a particle filter or performing a mean shift method (refer to a technique disclosed in Japanese Patent application No. 2009-051173 as a related technique). Further, with respect to a method for tracing the flow line of the worker, an appropriate method may be employed without being limited to such a technique. Here, the camera may be a wide-angle lens camera, such as a camera using a fish-eye lens or a camera with a mirror of all directions. Further, each of the location detection devices 2 is capable of transmitting image data to the flow line data analysis device 1 via wireless communication or wired communication.

Further, each of the location detection devices 2 may be configured to perform location detection by using wireless signals from a mobile terminal carried by the worker, and transmit a detected location of the mobile terminal to the flow line data analysis device 1 so as to allow the flow line data analysis device 1 to generate partial flow line data related to the worker on the basis of transmitted locations of the worker. Moreover, each of the location detection devices 2 may be also configured so as to be capable of performing location detection by using ultrasonic waves and perform location detection while receiving ultrasonic waves from an ultrasonic generation device carried by the worker, or may be also configured to perform location detection while detecting reflected waves which arise when a worker has passed by one of ultrasonic generation devices which are installed at some places inside a warehouse or the like. Besides, each of the location detection devices 2 may be also configured to transmit the location of the worker to the flow line data analysis device 1 by using a different appropriate means which can be used for a specification of the location of a worker, so as to allow the flow line data analysis device 1 to generate partial flow data related to the worker on the basis of the transmitted locations of the worker. For example, the detection of the location of a worker may be performed by using, for example, a global positioning system (GPS) terminal; a terminal in which an acceleration sensor and an gyro sensor is combined; or RFID readers as well as RFID tags each for use in location detection and carried by a worker.

Here, each of the location detection devices 2 may be configured to perform not only detection but also a generation of the worker flow line data including data related to traces of the worker, and transmit the worker flow line data to the flow line data analysis device 1. In this case, as a result, the location detection device is provided with a flow line data generation portion.

The handy terminal 3, which is a terminal carried by the worker, acquires work log having been described in the above description of the log DB 11b in the above-mentioned storage unit 11, and transmits the acquired work log to the flow line data analysis device 1. The article information can be detected by attaching a wireless tag, such as an RFID tag, onto an article, and utilizing a wireless communication technique, such as radio frequency identification (RFID) technique. Further, the article information may be detected by attaching a barcode onto an article, and using a barcode reader. In addition, in this exemplary embodiment, any device capable of detecting that a specific worker has worked on a specific article, and transmitting log of the work to the flow line data analysis device 1 can be used in substitution for the handy terminal. Moreover, the handy terminal 3 may be a tablet terminal in which such a work check list application as is capable of verifying work items and recording work clock times is embedded.

Next, operations of this exemplary embodiment will be described with reference to FIGS. 1 and 2. In a flowchart shown in FIG. 2, there are described operations in which the control unit 13 associates a piece of key information (a piece of worker information or a piece of slip information) included in work log with flow line data. These operations may be performed in such a program as is executed in a single computer.

The control unit 13 extracts work information corresponding to a piece of specific key information from work log stored in the log DB 11b (S101). As an example, the control unit 13 extracts clock time (log clock time information) at each of which a specific worker has worked on an article, and the like, from work log. Next, the control unit 13 determines whether each of a plurality of partial flow line data stored in the flow line DB 11a includes a piece of flow line work information which satisfies any one of predetermined conditions each determined in accordance with the extracted work information (S102). As an example, the control unit 13 extracts log clock time information corresponding to a piece of specific key information, and determines whether each of a plurality of partial flow line data includes time information which falls within a predetermined range from the log clock time information. In this case, the control unit 13 may determine whether each of the plurality of partial flow line data includes a plurality of flow line work information each of which satisfies predetermined condition each determined from work information corresponding to specific identical key information. Further, in the case where it is determined that each of a plurality of specific partial flow line data includes flow line work information which satisfies one of the predetermined conditions, the control unit 13 associates the piece of key information with the plurality of specific partial flow line data and thereby generates interlinked flow line data (S103).

According to this exemplary embodiment of the present invention, the above-described configuration makes it possible to generate interlinked flow line data related to an identical person by interlinking a plurality of flow line data each related to the identical person without making collation on a person image basis. Moreover, since an association of work log with flow line data is made, the position of each of cameras is sufficient provided that each of the cameras is placed at a position at which flow line data can be acquired, so that it is possible to apply some aspects of the invention even when a place, such as a warehouse or a factory, in which target workers do not always pass by a specific place, is a target for analyzing flow lines.

Here, in substitution for the above-described operation in S102, the control unit 13 detects flow line work action information from a plurality of partial flow line data or the outputs of the location detection devices 2 by utilizing an image analysis technique. Further, the control unit 13 may be configured to, through the use of a list in which flow line work information (time information or place information) are each associated with the detected flow line work action information, determine whether each of a plurality of partial flow line data includes a piece of flow line work information which is included in the listed flow line work information and which satisfies any one of predetermined conditions each determined in accordance with the extracted work information. The piece of flow line work action information is a piece of information related to an action which suggests a work which is supposed to have been performed by a worker. The action suggesting a work which is supposed to have been performed by a worker means an action, such as stopping, squatting, passing by a place where articles are arranged, stretching the arm, picking up an article, placing an article on a shelf, bolting, drilling and cutting with tools, installing a component, or painting. In such a way as described above, it becomes possible to make a determination on a plurality of partial flow line data merely by retrieving associated table information, and thus, it is possible to achieve the reduction of processing loads as well as the improvement of a processing speed.

In any one of the following exemplary embodiments, any action capable of associating flow line data with a piece of worker identification information can be built in a range as far as those involved can conceive.

### Exemplary Embodiment 2

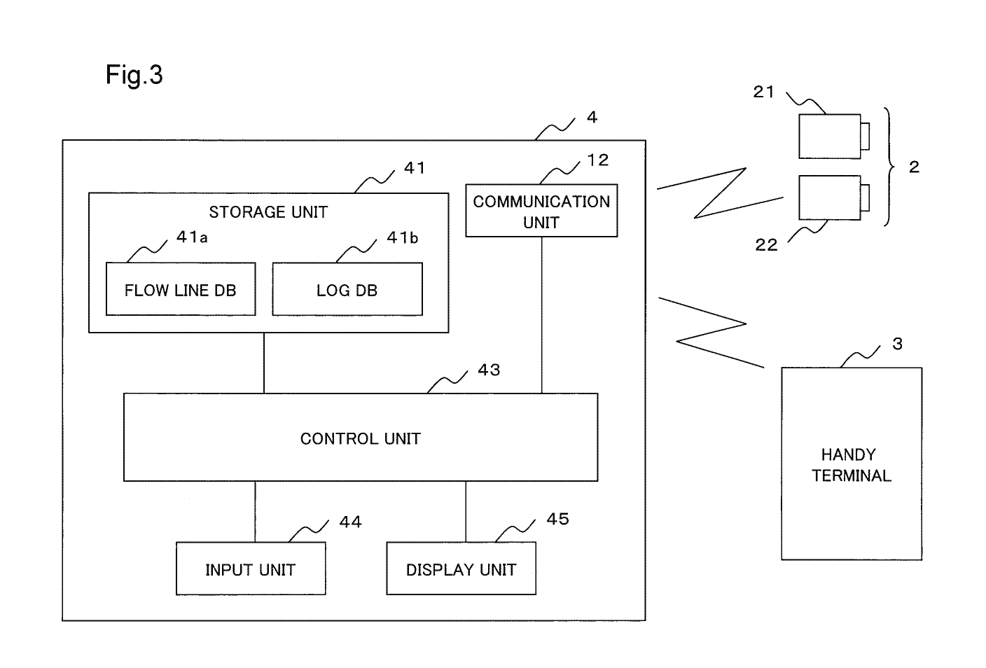

Next, an exemplary embodiment 2 will be described with reference to FIGS. 3 to 7. The same constituent elements as those of the exemplary embodiment 1 are each denoted by the same sign as that in the exemplary embodiment 1, and the description thereof will be omitted. In this exemplary embodiment 2, as the article work information in the exemplary embodiment 1, log clock time information at each of which a worker has performed a work on an article is extracted. Further, in this exemplary embodiment 2, through the use of, as flow line work information in the exemplary embodiment 1, time information related to movement of worker associated with a plurality of partial flow line data, it is determined whether each of a plurality of partial flow line data includes time information which falls within a predetermined range from the log clock time information included in work log.

In FIG. 3, there is illustrated a flow line data analysis system of this exemplary embodiment 2. As one of configurations of such a flow line data analysis system, a flow line data analysis device 4 includes a storage unit 41, a control unit 43, an input unit 44 and a display unit 45.

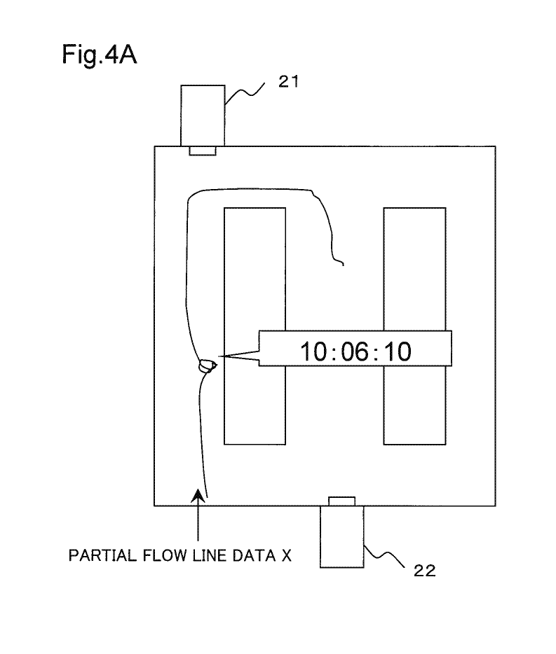

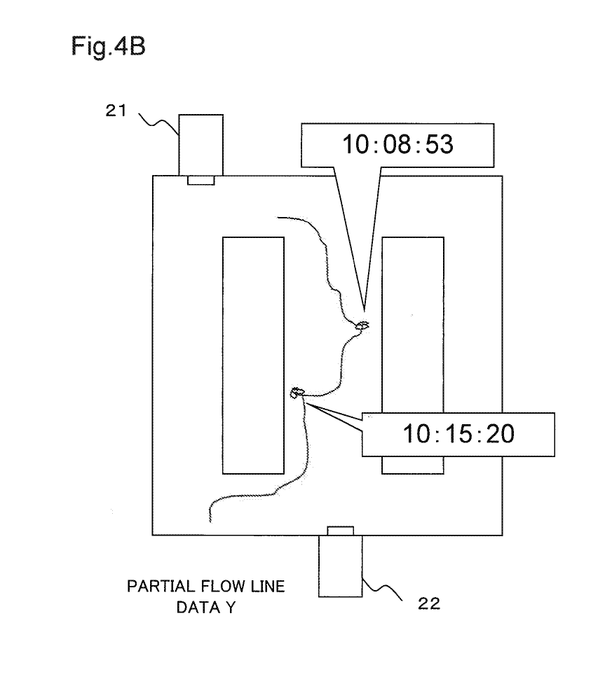

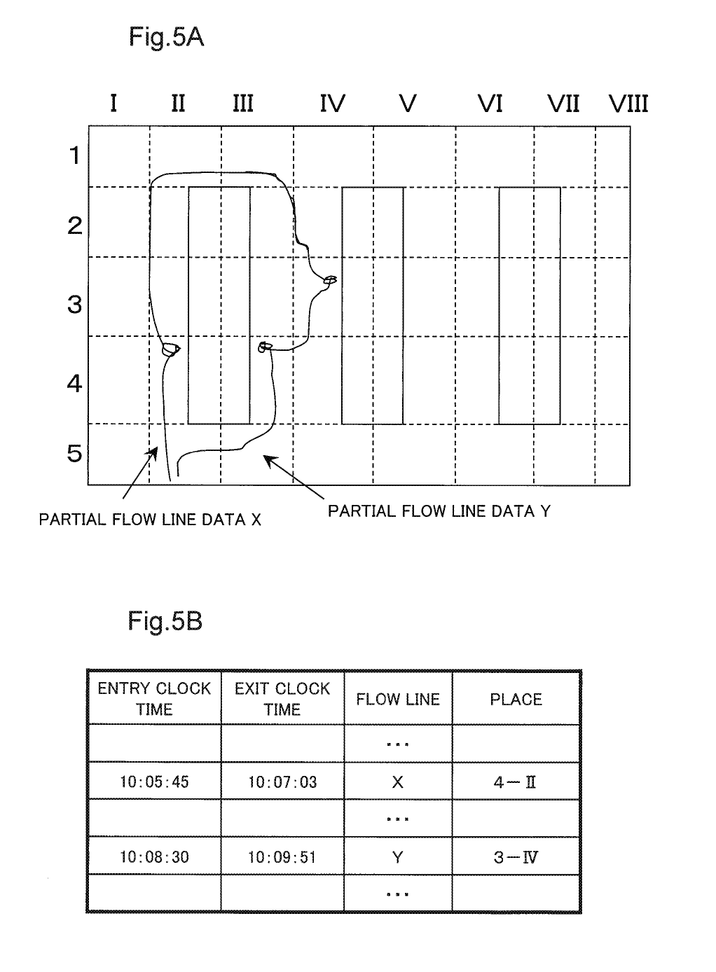

The storage unit 41 includes a flow line DB 41a and a log DB 41b. The flow line DB 41a stores therein partial flow line data each generated by the control unit 43 from image data from each of location detection devices 2. An example of the partial flow line data will be described with reference to FIGS. 4A, 4B, 5A, 5B and 6. FIG. 4A and FIG. 4B are diagrams each illustrating a track of a movement of a worker in a warehouse or a factory. In FIG. 4A and FIG. 4B, there are illustrated, besides the tracks, pieces of clock time information each associated with points on the tracks. These pieces of clock time information may be continuously detected but, alternatively, may be intermittently detected at intervals of a constant period of time. In FIG. 4A, there is illustrated partial flow line data obtained through a camera 21; while, in FIG. 4B, there is illustrated partial flow line data obtained through a camera 22. In FIG. 5A, there is illustrated an example in which each of flow line data within a photographing place of a warehouse or a factory is segmented by using grids just like such squares on a Go board. In FIG. 5B, there is illustrated an example in which entry clock times and exit clock times of a worker to/from their respective corresponding cells are indicated so as to form a list. A piece of time information as a piece of flow line work information in FIG. 5B may be a clock time having a width from an entry clock time until an exit clock time, or may be also a single clock time within a period of time when a worker exists within one of cells (for example, a clock time when a worker has come near the center of a cell or a clock time when a worker has come near a shelf). Further, a piece of place information in FIG. 5A may not be a piece of information resulting from segmenting a photographing place by using grids just like such squares on a Go board, but may be replaced by one of identification numbers for identifying paths.

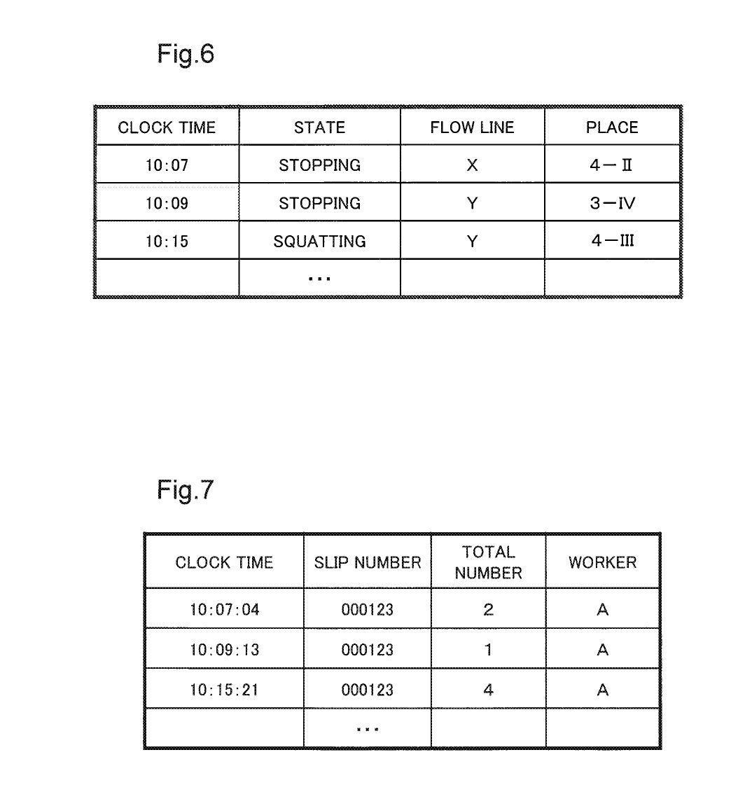

As shown in FIG. 6, flow line work action information (for example, stretching of an arm, picking up of an article, and the like), which are extracted beforehand from image data from each of the location detection devices 2 by utilizing an image recognition technique, may be stored in a storage unit so as to form a list, together with time information each associated with flow line work action information. Through the use of a list of such preliminarily extracted flow line work action information, when associating a piece of key information with each of partial flow line data, as compared with a case where each of the pieces of flow line work action information is extracted in series, it is possible to achieve the reduction of processing wait time, the reduction of concentration of processing loads and the improvement of a processing speed.

The log DB 41b stores therein a work log which has been transmitted from the handy terminal 3 and has been received via the communication unit 12. In FIG. 7, there is illustrated an example of the work log. Here, the work log includes data representing information related to articles on which a worker has worked, and forms a list containing key information as well as article work information. In FIG. 7, the list includes, as the key information, worker information related to the worker (a name, a code or the like) and slip information (a slip number or the like). Further, the list includes, as the article work information, log clock time information at which a worker has worked on article as well as a total number of articles regarding the article. In addition, without being limited to these, other kinds of information, such as a manufacturer of an article, may be managed in this list. In addition, here, the log clock time information may not be necessarily an accurate clock time when a worker has picked up an article, but may be, for example, a clock time when a worker has checked an article with a handy terminal. As described above, even when there is a small difference between a clock time when a worker has worked on an article and a clock time when the worker has checked an article included in the article, there is no problem because, in this exemplary embodiment, it is confirmed whether each of partial flow line data includes a piece of time information which falls within a predetermined range from log clock time information.

The control unit 43 is capable of detecting pieces of flow line work action information from partial flow line data or image data from location detection devices. The piece of flow line work action information indicates an action taken by a worker who performs a work on an article, such as a stopping action, an arm stretching action, a squatting action, or an action taken by a worker who has come near a shelf. Here, it can be detected whether a worker has passed by a shelf by determining, for example, whether the location of a worker existing on a path is within an area distanced from a shelf by a distance smaller than or equal to one second of the width of the path (which can be appropriately changed to a different distance, such as a distance smaller than or equal to one third of the width of the path), or whether a track corresponding to a target partial flow line data related to a worker is contacted with a shelf. In this exemplary embodiment, as an example, a stopping action is extracted as a piece of flow line work action information. A stopping action detection method performed by the control unit 43 can be realized by, through the use of partial flow line data, identifying a position corresponding to a fixed place at which a worker has stayed for a long time, or a position which corresponds to a place close to a shelf and on which traces of a movement of a worker are concentrated.

Further, upon detection of a piece of flow line work action information, the control unit 43 can extract a piece of time information corresponding to the piece of flow line work action information. Here, the piece of time information corresponding to the piece of flow line work action information indicates a clock time having a width from a clock time when an action, which is associated with the piece of flow line work action information and which suggests that a worker has performed a work on an article, has begun until a clock time when the action associated with the flow line work action information has ended. Alternatively, the piece of time information corresponding to the piece of flow line work action information may be a specific clock time, such as a middle clock time, between a clock time when an action, which is associated with the piece of flow line work action information and which suggests that a worker has performed a work on an article, has begun and a clock time when the action associated with the piece of flow line work action information has ended. Further, the control unit 43 extracts pieces of log clock time information corresponding to a piece of specific key information, and determines whether each of partial flow line data includes a piece of time information which is included in the extracted pieces of time information and which falls within a predetermined range from the extracted log clock time information. Further, in the case where it is determined that each of a plurality of specific partial flow line data includes flow line work information which satisfies the predetermined condition, the control unit 43 generates interlinked flow line data by interlinking the plurality of specific partial flow line data.

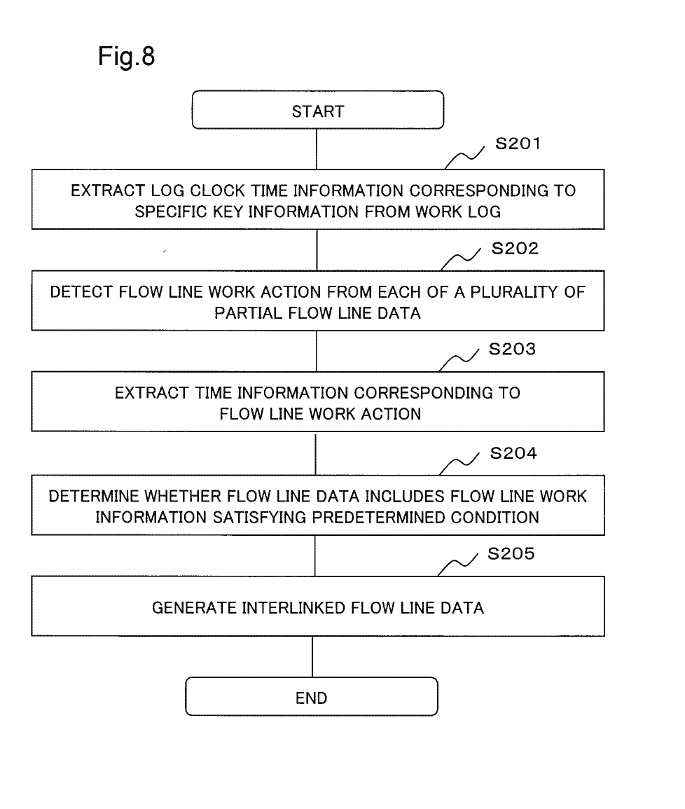

Next, operations performed by the control unit 43 will be described with reference to FIGS. 3 to 8. FIG. 8 illustrates a flowchart of operations performed by the control unit 43. In addition, these operations may be performed in such a program as is executed in a single computer.

The control unit 43 extracts pieces of log clock time information corresponding to a piece of specific key information (such as an identical worker, an identical slip number) from work log stored in the log DB 41b (S201). As an example, referring to FIG. 7, pieces of log clock time information “10:07:04”, “10:09:13” and “10:15:21” corresponding to a worker A or a slip number “000123”, which is a piece of specific key information, are extracted. In addition, the number of pieces of log clock time information to be extracted may be one.

Next, the control unit 43 detects pieces of flow line work action information from partial flow line data stored in the flow line DB 11a (S202). As an example of the piece of flow line work action information, a stopping action can be detected. A detection method for detecting such a stopping action can be realized by, for example, detecting a state where a track of a movement of a worker is not moving from a fixed area during a predetermined period of time, from partial flow line data shown in FIG. 4A and FIG. 4B. Further, the detection method for detecting the stopping action can be realized by detecting a state where a track of a movement of a worker is staying at a specific area (a path or the like) during a period having a length longer than or equal to a predetermined period of time, from partial flow line data shown in FIG. 5A. Further, since image data from each of the location detection devices 2 are analyzed in advance, and a list of pieces of flow line work action information and pieces of time information is generated, it is possible to, through a retrieval of each of partial flow line data shown in FIG. 6, detect one or more pieces of flow line work action information corresponding thereto.

Further, the control unit 43 extracts pieces of time information each associated with the flow line work action information (S203). As an example, referring to FIG. 4A and FIG. 4B, a clock time “10:06:10” can be detected as a piece of time information of the partial flow line data X, and clock times “10:08:53” and “10:15:20” can be detected as pieces of time information of the partial flow line data Y.

Next, the control unit 43 determines whether each of the partial flow line data includes a piece of time information which falls within a predetermined range from the extracted log clock time information (S204). As an example, let us consider a case where it is determined whether any one of the extracted pieces of time information falls within a range of one minute in each of an upward direction and a downward direction from the aforementioned log clock time information “10:07:04”, “10:09:13” and “10:15:21” corresponding to the worker A (or the slip number “000123”). It can be understood that the time information “10:06:10”, which is associated with the partial flow line data X, and the time information “10:08:53” and “10:15:20”, which are associated with the partial flow line data Y, each fall within one minute in each of an upward direction and a downward direction from the aforementioned log clock time information. As a result, the control unit 43 can determine that the partial flow line data X and Y each include at least a piece of time information each falling within a predetermined range from the log clock time information corresponding to the worker A. Here, the method for determining whether any one of extracted pieces of time information falls within a predetermined range from extracted log clock time information is equivalent to selecting an association which causes an average value of the sum of a difference value between each of the time information and each of the pieces of log clock time information to be minimum, that is, searching for pairs each of which includes one of the pieces of time information and one of the pieces of log clock time information and causes a difference value therebetween to be minimum. As described above, a piece of log clock time information may not necessarily coincide with a piece of time information extracted from a piece of flow line work action information, and a piece of time information, which is one of the pieces of time information extracted from the pieces of flow line work action information and which is close to one of the pieces of log clock time information, can be associated. Further, it is also possible to make an association after having narrowed partial flow line data targeted for the association by using an earliest clock time and a latest clock time included in each of pieces of log clock time information corresponding to a piece of specific key information.

Further, in the case where it is determined that each of a plurality of specific partial flow line data includes a piece of time information which satisfies a predetermined range from log clock time information, the control unit 43 generates interlinked flow line data by interlinking the plurality of specific partial flow line data (S205). As an example, it can be determined that each of the plurality of partial flow line data X and Y includes at least a piece of time information each of which falls within a range from log clock time information corresponding to the worker A (or the slip number “0001231”), and thus, the control unit 43 generates interlinked flow line data by interlinking the partial flow line data X and Y.

As described above, in an aspect of the present invention, it is possible to, without making collation on a person image basis, generate interlinked flow line data by using picking clock times in work log as well as pieces of time information each associated with flow line work actions extracted from a plurality of partial flow line data. Further, it is possible to improve the degree of accuracy of mutual associations among interlinked partial flow line data to a greater degree as compared with the case of the exemplary embodiment 1 by using picking clock times as well as pieces of time information. Moreover, it is possible to further improve the degree of accuracy of an association of a piece of specific key information with partial flow line data each related to a worker by extracting a plurality of pieces of log clock time information and associating the pieces of log clock time information with a plurality of pieces of time information each associated with one of a plurality of pieces of flow line work action information which are extracted from each of the partial flow line data.

Here, a beginning of these operations may be a beginning of an operation of this exemplary embodiment, which is an administrator's designation of a worker or flow line data as desired association target, using the input unit 44 and the display unit 45.

Further, in substitution for the above-described operations of S202 to S204, without extracting the pieces of time information each associated with the flow line work action information related to the partial flow line data X, the control unit 43 may determine whether each of a plurality of partial flow line data includes a piece of time information which falls within a predetermined range from log clock time information. Specifically, through a direct comparison of pieces of log clock time information with at least a piece of time information each of which indicates a worker's movement and which is included in each of a plurality of partial flow line data, the control unit 43 may determine whether each of the at least a piece of time information falls within a range of one minute in each of an upward direction and a downward direction from the aforementioned log clock time information (“10:07:04”, “10:09:13” and “10:15:21”) corresponding to the worker A. In this way, it is possible to eliminate pieces of flow line data each having a time zone completely different from a time zone of each of the pieces of log clock time information. Alternatively, through the above-described elimination processing as preliminary processing to be performed prior to the operations in S202 to S204, the consumption of computation processing resources of a system can be suppressed, so that an association of specific key information with flow line data can be made efficiently.

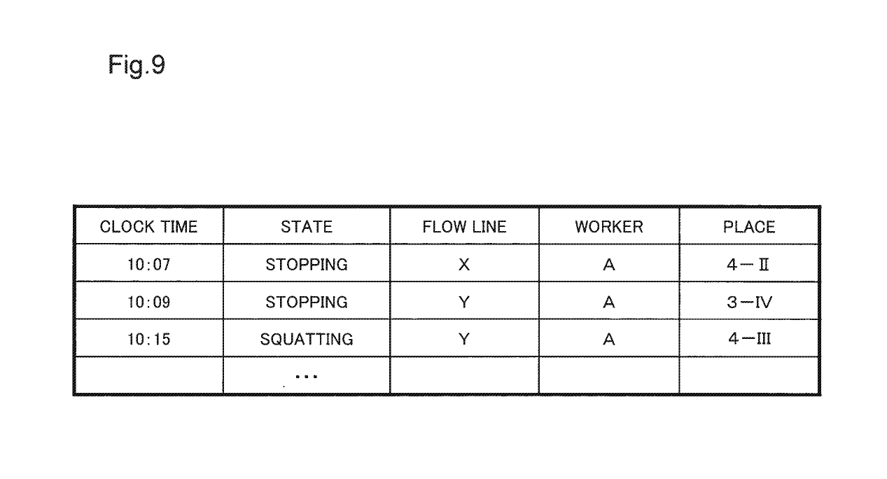

Moreover, through the above-described operations, as a result of an association of a piece of specific key information with of flow line data corresponding to a worker, the control unit 43 can newly generate a list, shown in FIG. 9, in which pieces of worker information related to workers are added.

### Exemplary Embodiment 3

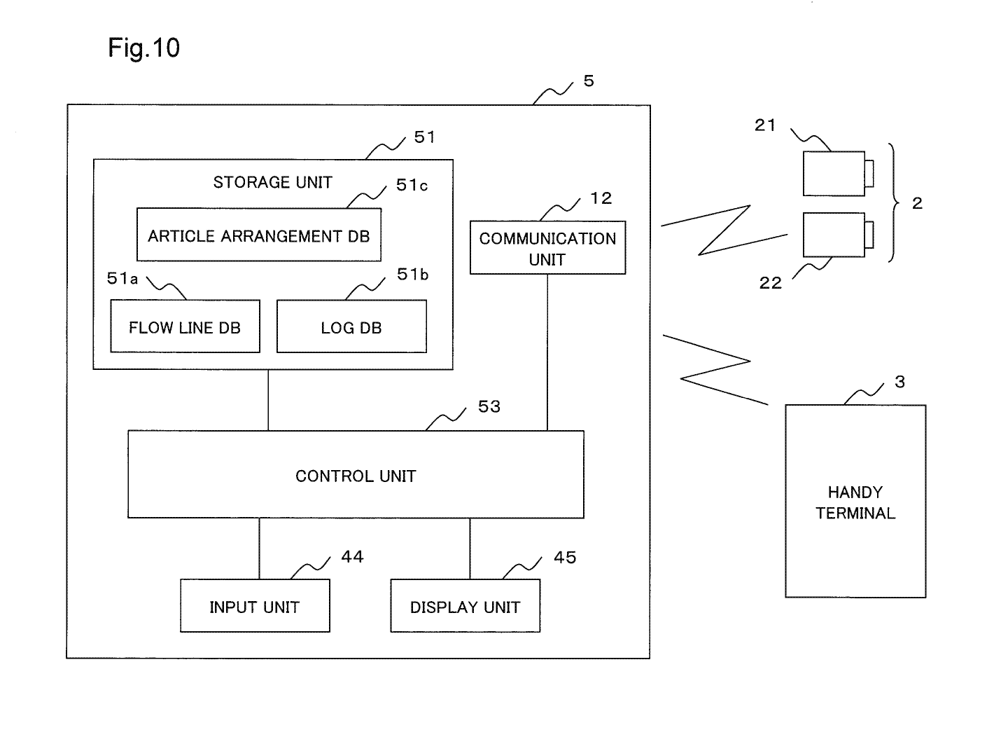

Next, an exemplary embodiment 3 will be described with reference to FIGS. 10 to 14. The same constituent components as those of each of the exemplary embodiments 1 and 2 are each denoted by the same sign as that in each of the exemplary embodiments 1 and 2, and the description thereof will be omitted. In this exemplary embodiment 3, as article work information, article information (for example, an article number, an article name and the like related to an article having been acquired or arranged by a worker) is used. Further, in this exemplary embodiment 3, article arrangement information, by each of which article information is associated with a piece of arrangement information (for example, warehouse coordinates, a shelf number, a grid number, a cell number or the like) corresponding to an article, are provided. Further, a control unit extracts article information corresponding to a piece of specific key information (a piece of worker information, a piece of slip information, or the like) from work log, and extracts arrangement places each associated with the extracted article information by using the article arrangement information. Next, the control unit determines whether each of partial flow line data includes a piece of place information (for example, warehouse coordinates, a shelf number, a grid number, a cell number or the like) which falls within a predetermined range from the extracted arrangement places. Further, in the case where it is determined that each of a plurality of specific partial flow line data includes a piece of place information which falls within a predetermined range from the arrangement places, the control unit generates interlinked flow line data by interlinking the plurality of specific partial flow line data.

In FIG. 10, there is illustrated a flow line data analysis system of this exemplary embodiment 3. As an example of such a flow line data analysis system, a flow line data analysis device 5 includes a storage unit 51 and a control unit 53.

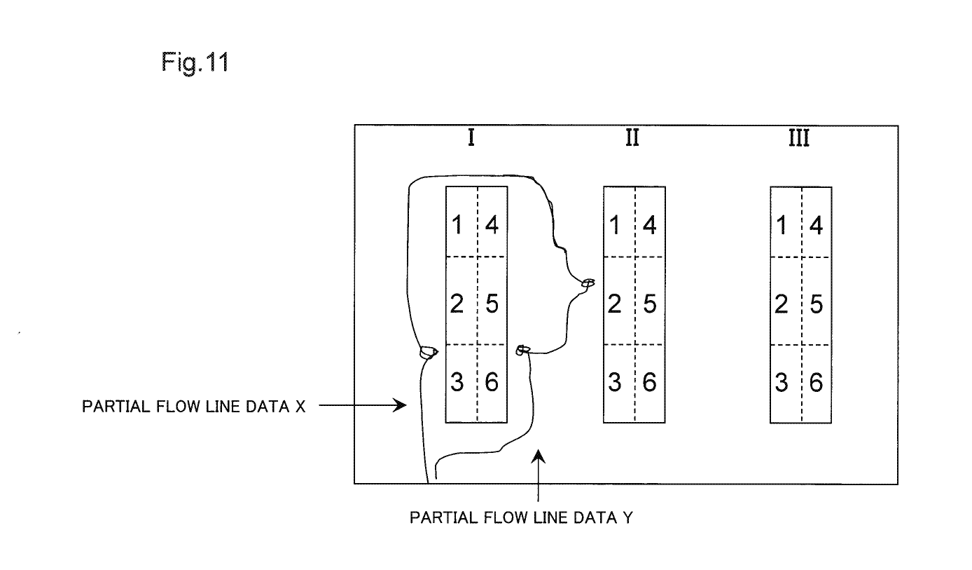

The storage unit 51 includes a flow line DB 51a, a log DB 51b and an article arrangement DB 51c. The flow line DB 51a stores therein partial flow line data each generated by the control unit 43 from image data outputted from location detection devices 2. An example of the partial flow line data will be described with reference to FIG. 11. FIG. 11 is a diagram illustrating tracks of movements of workers in a warehouse or a factory (partial flow line data X and Y) as well as pieces of place information (shelf numbers).

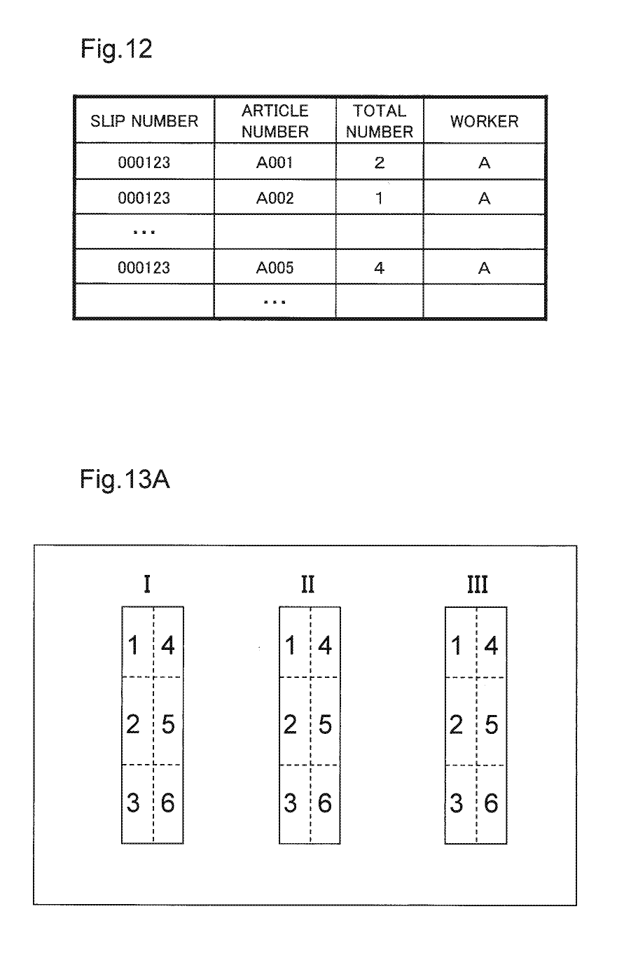

The log DB 51b stores therein a work log which has been transmitted from the handy terminal 3 and has been received via the communication unit 12, and retains a plurality of the work log as work log. In FIG. 12, there is illustrated an example of the work log. Here, the work log includes pieces of data representing some kinds of information related to articles on each of which a worker has worked, and forms a list containing pieces of key information as well as article work information. In FIG. 12, the list includes, as the piece of key information, a piece of worker information related to a worker (a name, a code or the like) and a piece of slip information (a slip number or the like). Further, the list includes, as the article work information, article information (an article number of an article on which a work, such as an acquisition or an arrangement, has been performed, and a total number of articles regarding the article). In addition, without being limited to these, other kinds of information, such as a manufacturer of an article, may be managed in this list.

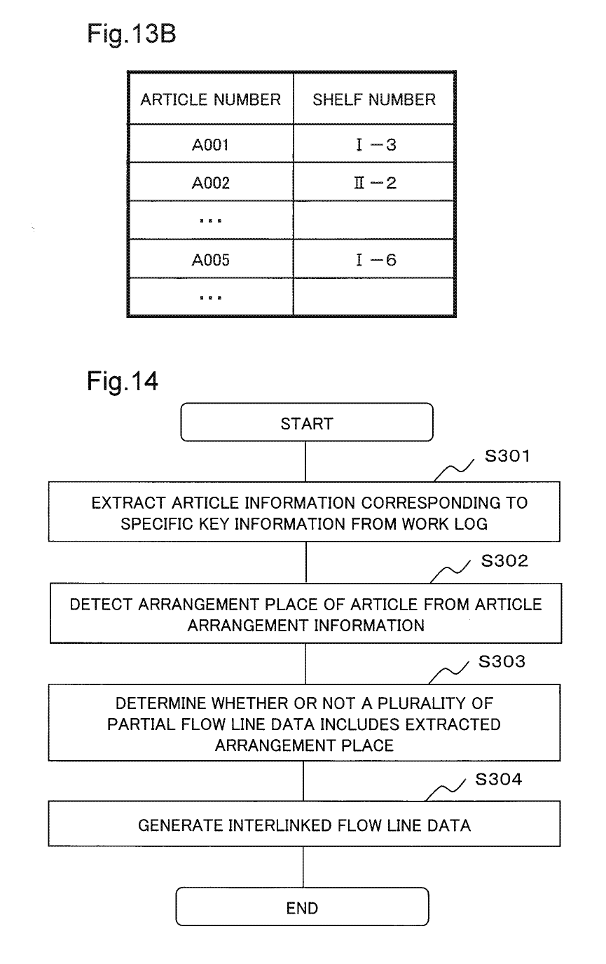

The arrangement DB 51c stores therein article arrangement information by each of which article information (an article number, an article name or the like) is associated with a piece of arrangement information (warehouse coordinates, a shelf number, a grid number, a cell number or the like) related to an article. Here, this piece of arrangement information is, for example, coordinates on a warehouse, which indicates a location where a corresponding article is arranged. Further, as another example of the piece of arrangement information, as shown in FIG. 13A and FIG. 13B, a shelf number at which an article is arranged may be stored together with article information so as to form a list. In this case, the article information can be associated with a piece of arrangement information related to an article by storing a different list in which a shelf number is associated with a corresponding coordinates on a warehouse. Moreover, as shown in FIG. 5A, the piece of arrangement information related to an article may be a grid number (or a cell number) corresponding to a segment of a constant shape, which results from segmentation of a region inside a warehouse or a factory. Further, in substitution for the article information corresponding to the piece of article arrangement information, any kind of information capable of identifying an article may be associated with a shelf number. Further, an object where articles are arranged may not be a shelf. As shown in FIG. 5A in the exemplary embodiment 2, the article arrangement DB 51c can also store therein, as article arrangement information constituting article arrangement information, an article and a grid number (or a cell number), which results from performing segmentation of a region of a warehouse or a factory into segments each having a constant shape, by associating the grid number, as a certain kind of information capable of identifying a article, with the article.

The control unit 53 extracts article information (such as, article numbers) from work log, and can extract pieces of arrangement information (warehouse coordinates, shelf numbers, grid numbers, cell numbers or the like) each associated with the article information, from the article arrangement information. Next, the control unit 53 can determine whether each of a plurality of partial flow line data includes a piece of place information (warehouse coordinates, a shelf number, a grid number, a cell number or the like) which falls within a predetermined range from the arrangement place. Further, the control unit 53 can detect pieces of place information each of which is related to a piece of partial flow line data and is associated with flow line work action information, from partial flow line data or image data from each of location detection devices. This piece of work action information indicates, just like in the case of the exemplary embodiment 2, an action taken by a worker who performs a work for an acquisition of an article, an arrangement of an article, or the like, such as a stopping action, an arm stretching action, a squatting action or an action taken by the worker who has come near a shelf. Further, the control unit 53 can extract shelf numbers of shelves each of which is located close to a place where an action indicated by one of the pieces of flow line work action information has been taken. Further, the control unit 53 determines whether any one of at least a piece of place information having been extracted from each of a plurality of partial flow line data falls within a predetermined range from the extracted arrangement information related to articles. In the case where each of a plurality of specific partial flow line data includes a piece of place information which falls within a predetermined range, the control unit 53 generates interlinked flow line data by interlinking the plurality of specific partial flow line data.

Next, operations performed by the control unit 53 will be described with reference to FIGS. 10 to 14. FIG. 14 is a flowchart illustrating operations of the control unit 53. In addition, these operations may be performed in such a program as is executed in a single computer.

The control unit 53 extracts article information (such as, article numbers) corresponding to specific key information (such as an identical worker or an identical slip number) from work log stored in the log DB 51b (S301). As an example, referring to FIG. 12, the control unit 53 extracts article numbers “A001”, “A002” and “A005” each associated with article on which a worker A has worked (or which are associated with a slip number “000123”). In addition, the number of the article information to be extracted may be one.

Next, the control unit 53 extracts arrangement information (such as warehouse coordinates, shelf numbers, grid numbers or cell numbers) each associated with the article information having been extracted in S301, by using the article arrangement DB 51c (S302). As an example, the control unit 53 extracts shelf numbers “II-6”, “II-1” and “I-3” which correspond to article numbers “A001”, “A002” and “A005”, respectively, by referring to FIG. 13B, and extracts warehouse coordinates each associated with the extracted shelf numbers from a separately generated list in which the shelf numbers and the warehouse coordinates are stored.

Next, the control unit 53 determines whether each of a plurality of partial flow line data includes a piece of place information which falls within a predetermined range from an arrangement place designated by the extracted arrangement information (S303). As an example, the control unit 53 determines whether any one of at least a piece of place information included in each of partial flow line data falls within a range of, for example, 100 centimeters from the extracted warehouse coordinates each having been extracted from the article arrangement information. Further, in the case where the piece of arrangement information is a grid number (or a cell number) on a warehouse, the control unit 53 may determine whether each of partial flow line data includes at least warehouse coordinates, each of which falls within a predetermined range from a position designated by the extracted grid numbers. Further, in the case where both of the piece of arrangement information and the piece of place information related to a piece of partial flow line data are each represented by a grid number (or a cell number), the control unit 53 may determine whether each of at least a grid number extracted from each of partial flow line data falls within a predetermined range from the extracted grid number. In addition, “within a predetermined range from an extracted grid number” means “within a range covering, for example, segments adjacent to a segment designated by the extracted grid number or segments falling within a range which is appropriately determined from a segment designated by the extracted grid number”. In the case where the article arrangement information is warehouse coordinate and the piece of place information related to partial flow line data is a grid number, the determination can be made in the same way as described above. In this case, the control unit 53 determines that the partial flow line data X includes a piece of place information which falls within 100 centimeters from the shelf number “I-3”, and the partial flow line data Y includes a piece of place information which falls in 100 centimeters from the extracted shelf numbers “II-6” and “II-1”.

Further, the control unit 53 generates interlinked flow line data by interlinking the partial line data X and Y (S304).

As described above, according to this exemplary embodiment, it is possible to, through the additional use of the article arrangement information, associate partial flow line data with a piece of worker identification information merely by calculating, as flow line work action information, a distance between a position of the worker passing by a shelf on which articles are arranged and a position of the shelf. Further, according to this exemplary embodiment, it is possible to generate interlinked flow line data by interlinking a plurality of partial flow line data, without using any image recognition technique of high accuracy for recognizing, for example, an action of stretching an arm towards the shelf.

Here, the control unit 53 can also generate interlinked flow line data through interlinking a plurality of partial flow line data by preliminarily generating a list including at least a piece of flow line work action information extracted from each of partial flow line data as well as at least a piece of place information (such as warehouse coordinates, a shelf number, a grid number or a cell number) close to a place corresponding to the at least a piece of flow line work action information, and comparing the at least a piece of place information for each of the partial flow line data with the pieces of arrangement information having been extracted in S30 shown in FIG. 14. Specifically, the control unit 53 detects at least a piece of flow line work action information from each of partial flow line data stored in the flow line DB 51a; extracts a piece of place information (such as warehouse coordinates, a shelf number, a grid number or a cell number) associated with each of the detected at least a piece of flow line work action information; and generates a list including the detected at least a piece of flow line work action information for each of the partial flow line data as well as the extracted piece of place information corresponding to the detected at least a piece of flow line work action information. In this case, the control unit can also detect, as a piece of flow line work information, an action which is taken by a worker who has come near a shelf, and which is recognized as a piece of flow line work action information. Further, the control unit 53 determines whether any one of at least a piece of place information extracted from each of a plurality of partial flow line data falls within a predetermined range from arrangement information extracted from article arrangement information. Through these processes, an association of a plurality of specific partial flow line data with a piece of worker identification information can be made merely by performing a mutual collation among pieces of table information, and thus, it is possible to achieve the reduction of processing wait time, the reduction of concentration of processing loads and the improvement of a processing speed.

### MODIFICATION EXAMPLES

Further, in each the aforementioned exemplary embodiments, it is also possible to generate a list in which priority levels each associated with article work information extracted from work log is stored for each articles; store the list in a storage unit; and make determinations in descending order from article work information which has the highest priority level. For example, as a reference level for the determination of the priority levels, a weight or a total number of an article can be used. In this way, since it becomes easy to extract pieces of flow line work action information because the length of a duration of a stopping action becomes longer as a weight of a target article become larger and/or a total number of picked articles becomes larger, it is possible to further improve the degree of accuracy of an association of a plurality of specific partial flow line data with a piece of worker identification information. Further, as a reference level for the determination of priority levels, a time zone related to a piece of partial flow line data can be used.

Moreover, any appropriate combination of the features of the aforementioned individual exemplary embodiments may be made. Specifically, a control unit extracts article numbers of article and pieces of log clock time information from work log, and further, extracts arrangement places (shelf numbers or warehouse coordinates) each associated with the article numbers from article arrangement information. Next, the control unit detects at least a piece of flow line work action information from each of a plurality of partial flow line data, and further, extracts at least a piece of place information (a shelf number or warehouse coordinates) and at least a piece of time information which are associated with each of the extracted at least a piece of flow line work action information. Further, a control unit determines whether place information having been extracted from each of the plurality of partial flow line data falls within a predetermined region range from the arrangement place of article, having been extracted from the article arrangement information, and concurrently therewith, the control unit determines whether time information having been extracted from each of the plurality of partial flow line data falls within a predetermined time range from the log clock time information, having been extracted from the work log. Further, in the case where it is determined that place information having been extracted from each of the plurality of partial flow line data and time information having been extracted from the each of the plurality of partial flow line data fall within a predetermined region range and a predetermined time range, respectively, the control unit can also generate interlinked flow line data by interlinking a plurality of specific partial flow line data. Through this processing, an association of a plurality of specific partial flow line data with worker identification information can be made merely by performing a mutual collation among table information, and thus, it is possible to achieve the improvement of the degree of accuracy of an association, as well as the reduction of a processing load and the improvement of a processing speed.

Further, as an appropriate combination of the features of the aforementioned individual exemplary embodiments, first, a control unit uses place information included in each of a plurality of partial flow line data, and determines whether place information falls within a predetermined region range determined from articles numbers included in work log. Subsequently, the control unit uses time information included in each of the plurality of partial flow line data, and determines whether time information falls within a predetermined region range determined from clock time information included in the work log. After having narrowed the plurality of partial flow line data to some extent in this way, the control unit may detect flow line work action information from each of a plurality of narrowed partial line data, and then, may concurrently make a first determination and a second determination: the first one being a determination as to whether place information (such as coordinates or a shelf number), which is associated with flow line work action information, falls within a predetermined region range from articles numbers included in work log; the second one being a determination as to whether place information (such as coordinates or a shelf number), which is associated with flow line work action information, falls within a predetermined time range from clock time information included in the work log. As a result, since the flow line work action information is detected from each of a plurality of narrowed partial flow line data, the number of partial flow line data targeted for a heavily-loaded process of detecting pieces of flow line work action information can be reduced, and thus, it is possible to achieve the reduction of a processing load.

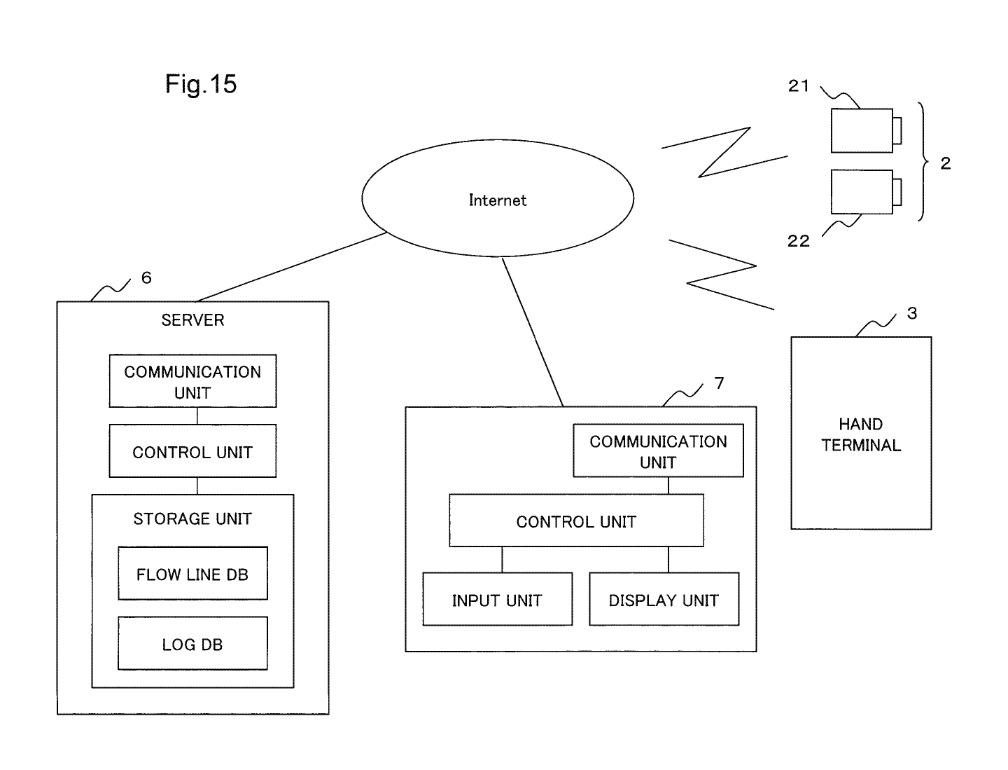

In each the aforementioned exemplary embodiment, as shown in FIG. 15, a configuration may be made such that the location detection devices 2 and the handy terminal 3 each transmit data to a flow line data analysis server 6 via the Internet, and the flow line data analysis server 6 includes the storage unit and the control unit of each of the aforementioned exemplary embodiments. In this way, a terminal 7 is connected to the flow line data analysis server 6, so that various kinds of data, such as work log and a plurality of partial flow line data, can be displayed on a display portion of the terminal 7. For this reason, an administrator of workers can obtain advantageous effects of some aspects of the present invention merely by being provided with the location detection devices 2, the handy terminal 3 and the terminal 7.

Further, in each the aforementioned exemplary embodiments, a configuration may be made such that, through the use of, besides work log information, pieces of information resulting from worker's operations of communication terminals (such as PCs) installed inside an warehouse or the like; a piece of specific key information (such as a piece of worker information) which interlinks a plurality of specific partial flow line data is specified; and interlinked flow line data is generated. Specifically, a storage unit stores therein pieces of information related to locations of communication terminals installed in a warehouse or the like. Further, each of the communication terminals has a function of notifying a control unit of a piece of worker information related to a worker having operated the communication terminal itself, or a slip number having been inputted to the communication terminal itself by a worker.

Operations of this configuration will be described. The control unit extracts a specific worker having operated some ones of the communication terminals. Further, the control unit extracts a plurality of partial flow line data each of which passes by an area near a place where one of the some ones of the communication terminals is installed. Further, the control unit identifies a piece of specific key information (such as a piece of worker information) which interlinks the plurality of partial flow line data, and generates interlinked flow line data. In this way, it is possible to further improve the degree of accuracy of an association of a piece of specific key information with a plurality of partial flow line data each related to a worker.

Further, in each of the aforementioned exemplary embodiments, the description has been made by way of an example in which targets for an analysis are flow line data each associated with workers who collect articles, but an object which collects articles may not human being but a riding machine, such as a forklift, an automated robot or a trained animal. Further, flow line data for use in such a case may not be ones for workers but ones for trained animals, automated robots, forklifts, cranes, trucks or the like.

Hereinbefore, the present invention has been described with reference to embodiments (practice examples), but are not limited to the aforementioned embodiments (practice examples). Various modifications that can be understood by those skilled in the art can be made on the configurations and details of the present invention within the scope of the present invention.

This application is based upon and claims the benefit of priority from Japanese patent application No. 2012-080278, filed on Mar. 30, 2012, the disclosure of which is incorporated herein in its entirety by reference.

### REFERENCE SIGNS LIST

1, 4 and 5: Flow line data analysis device
2: Location detection device
3: Handy terminal
6: Flow line data analysis server

1. A flow line analysis device comprising:
a log storage unit which stores work log including key information which encompasses at least one of worker information, slip information and work item, and work information associated with key information;
a flow line storage unit which stores a plurality of partial flow line data associated with the worker; and
a control unit,
wherein the control unit extracts work information associated with a specific key information from the work log, determines whether each of the plurality of partial flow line data which includes flow line work information which satisfies a predetermined condition defined by work information, and associates the key information with the flow line data when it is determined that the flow line data includes the flow line work information.

2. The flow line analysis device according to claim 1,
wherein the work information is article information which includes an article number or an article name of related to a past work of the worker,
wherein the storage unit further stores article arrangement information representing an arrangement place of the article information,
wherein the flow line work information is place information which is included in the partial flow line data and which represents a place related to a past movement of the worker, and
wherein the control unit extracts the article work information which is associated with a specific key information, extracts arrangement place determined from the article work information by using the article arrangement information, and determines whether each of the plurality of partial flow line data includes the place information which falls within a predetermined range from the arrangement place.

3. The flow line analysis device according to claim 1,
wherein the work information is log clock time information representing a clock time of a past work of the worker; the flow line work information is time information which represents a clock time related to a past movement of the worker into the flow line data, and
wherein the control unit extracts the log clock time information which are associated with a specific key information, and determines whether each of the plurality of partial flow line data includes the time information which falls within a predetermined range from the log clock time information.

4. The flow line analysis device according to claim 1,
wherein the control unit detects flow line work action information representing a past work of the worker, from each of the plurality of partial flow line data, and extracts flow line work information included in the flow line work action information, and determines whether flow line work information included in each of the plurality of partial flow line data satisfies a predetermined condition determined in accordance with the article work information.

5. The flow line analysis device according to claim 1,
wherein the storage unit further stores determination priority level information associated with the article work information, and
wherein the control unit makes determination in descending order from the article work information which has the highest priority level on the basis of the determination priority level information.

6. A flow line data analysis system comprising:
the flow line data analysis device according to claim 1;
a plurality of location detection devices each of which generates photograph data; and
a communication terminal which generates information constituting the work log by using a wireless tag reader, and transmits the generated information to the flow line data analysis device.

7. A flow line analysis method comprising:
storing work log including key information which encompasses at least one of worker information, slip information and work item, and work information associated with key information;
storing a plurality of partial flow line data associated with a worker;
extracting work information associated with a specific the key information from the work log;
determining whether each of the plurality of partial flow line data which includes flow line work information which satisfies a predetermined condition determined in accordance with the work information; and
associating the specific key information with the flow line data when it is determined that each of a plurality of specific partial flow line data included in the plurality of partial flow line data includes flow line work information.

8. The flow line analysis method according to claim 7,
wherein the work information is article information which includes an article number or an article name of the article related to a past work of the worker;
wherein the flow line work information is place information which represents a place related to a past movement of the worker, and
further comprising:
storing article arrangement information representing an arrangement place of the article;
extracting the article work information which is associated with a specific key information;
extracting an arrangement place determined from the article work information by using the article arrangement information; and
determining whether each of the plurality of partial flow line data includes the place information which falls within a predetermined range from the arrangement place.

9. The flow line analysis method according to claim 7,
wherein the work information is log clock time information representing a clock time of a past work of the worker;
wherein the flow line work information is time information which represents a clock time related to a past movement of the worker, and
further comprising:
extracting the log clock time information which is associated with a specific key information; and
determining whether each of the plurality of partial flow line data includes the time information which falls within a predetermined range from the log clock time information.

10. A non-transitory computer readable medium stores a program making a computer operate as functions for analyzing flow line data, comprising:
a log storage unit which stores work log including key information which encompasses at least one of worker information, slip information and work item, and work information associated with the key information;
a flow line storage unit which stores each of a plurality of partial flow line data of the worker;
an extraction unit which extracts work information associated with specific key information from the work log;
a determination unit which determines whether each of the plurality of partial flow line data which includes flow line work information which satisfies a predetermined condition defined by work information;
a flow line data generation unit which generates a interlinked flow line data associating with a plurality of partial flow line data when it is determined that each of the plurality of partial flow line data includes the flow line work information.

11. A flow line analysis device comprising:
a log storage means for storing unit which stores work log including key information which encompasses at least one of worker information, slip information and work item, and work information associated with key information;
a flow line storage means for storing unit which stores a plurality of partial flow line data associated with the worker; and
a control unit,
a control means for extracting wherein the control unit extracts work information associated with a specific key information from the work log, determining and determines whether each of the plurality of partial flow line data which includes flow line work information which satisfies a predetermined condition defined by work information, and associating and associates the key information with the flow line data when it is determined that the flow line data includes the flow line work information.
